(19) United States
(12) Patent Application Publication
(10) Pub. No.: US 2016/0082411 A1
(43) Pub. Date: Mar. 24, 2016

(54) SOLID CARBON DIOXIDE ABSORBENT COMPOSITION AND SOLID CARBON DIOXIDE ABSORBENT CONTAINING THE SAME

(71) Applicant: KOREA ELECTRIC POWER CORPORATION, Seoul (KR)

(72) Inventors: Tae Hyoung EOM, Daejeon (KR); Chong Kul RYU, Daejeon (KR); Joong Beom LEE, Daejeon (KR); Jeom In BAEK, Daejeon (KR); Kyeong Sook KIM, Daejeon (KR)

(21) Appl. No.: 14/888,898

(22) PCT Filed: Jun. 18, 2014
(86) PCT No.: PCT/KR2014/005330

§ 371 Date: Nov. 3, 2015

(30) Foreign Application Priority Data
Sep. 30, 2013 (KR) 10-2013-0115820

(51) Int. Cl. B01J 20/04; B01D 53/62; B01D 53/81

(52) U.S. Cl. CPC B01J 20/043; B01D 53/81; B01D 53/62; B01D 2253/104; B01D 2253/106; B01D 2253/1124; B01D 2258/0283; B01D 2257/504

(57) ABSTRACT

The present invention relates to a solid carbon dioxide absorbent composition for removing carbon dioxide, and includes an active material, a support, and an inorganic binder, wherein the support relates to the solid carbon dioxide absorbent composition including an aluminum compound and two or more kinds of tetravalent metal oxides.

### TECHNICAL FIELD

The present invention relates to a solid carbon dioxide absorbent composition capable of effectively removing carbon dioxide from gas containing carbon dioxide and a solid carbon dioxide absorbent containing the same. The solid absorbent of the present invention may be suitable for a dry regeneration CO₂ capture process in which carbon dioxide formed by burning fossil fuels, such as coal and biomass, is removed by a method of contacting a solid with gas at a temperature of 250° C. or less.

### BACKGROUND ART

As a method of removing carbon dioxide from a large-scale carbon dioxide generation facility, there are various methods such as wet chemical absorption, absorption, membrane separation, and cryogenic separation. However, these methods have limitations in that recovery costs may be high or these methods may be difficult to be used in large-scale industry.

A carbon dioxide capture technique using a dry regenerated absorbent, which is recognized as an innovative technique for efficiently and economically capturing carbon dioxide from a large amount of flue gas, is a technique of treating carbon dioxide using solid particles called as dry regenerated CO₂ absorbent. The above method is a technique in which the solid particles, instead of a liquid solvent used in a typical wet chemical absorption, are used to allow carbon dioxide present in the flue gas to be reacted with an active component of the solid absorbent to form a stable compound, pure carbon dioxide is then separated by using water vapor and additional heat source, and the absorbent is repeatedly and continuously reused by regeneration.

The dry regeneration absorption technique is characterized in that waste water is hardly generated, it has less corrosion issues, inexpensive various materials may be used, and the absorbent may be repeatedly used by regeneration. Also, the dry regeneration absorption technique is sustainable and has a larger potential than other techniques in various aspects such as small footprint due to the use of a fluidized bed process, excellent heat transfer properties, ease of process operation, design flexibility, environmental friendliness, small renewable energy, and highly efficient carbon dioxide absorbing power (absorbency and reactivity).

As a prior art related to the above dry regeneration carbon dioxide capture technique, although techniques mainly related to a combination of an active substance, a support, and inorganic and organic binders, or a combination of the active substance and support, or the active substance itself, have been known, these techniques are intended for the application in quite different areas. Thus, these techniques are not suitable for preparing an absorbent in large quantities because preparation methods are different from each other, for example, preparation by physical mixing or preparation by an impregnation method, and, in particular, these techniques are not suitable for being used in a process in which solid absorbent particles capture and separate carbon dioxide while continuously circulating two reactors of absorption and regeneration of a fluidized bed process. Therefore, it is inefficient to apply these techniques to an industrial process for discharging a large amount of carbon dioxide, for example, power plant, steel, refining, and cement industries.

### DISCLOSURE OF THE INVENTION

### Technical Problem

The present invention provides a raw material composition for preparing a solid absorbent which has high reactivity so as to remove carbon dioxide from gas containing carbon dioxide and may be continuously used in a dry regeneration capture process by suppressing a side reaction in a reaction process of the carbon dioxide and the absorbent.

The present invention also provides a solid carbon dioxide absorbent which may recover the captured carbon dioxide into high-purity carbon dioxide.

### Technical Solution

According to an aspect of the present invention, there is provided a solid carbon dioxide absorbent composition for removing carbon dioxide including an active component; a support; and an inorganic binder, wherein the support includes an aluminum compound and two or more kinds of tetravalent metal oxides.

According to another aspect of the present invention, there is provided a solid carbon dioxide absorbent including the solid absorbent composition according to the present invention.

According to another aspect of the present invention, there is provided a dry carbon dioxide capturing device including an absorption reactor in which the solid carbon dioxide absorbent is in contact with gas containing carbon dioxide to generate a reaction in which the solid carbon dioxide absorbent absorbs the carbon dioxide; and a regeneration reactor in which the carbon dioxide-absorbed solid carbon dioxide absorbent is in contact with carbon dioxide, air, nitrogen, water vapor, or a mixed gas thereof at a temperature of 250° C. or less to generate a reaction in which the solid carbon dioxide absorbent is regenerated.

### Advantageous Effects

A solid carbon dioxide absorbent composition according to the present invention may significantly improve carbon dioxide sorption capacity as well as regeneration capacity of the absorbent in a high concentration carbon dioxide atmosphere. Accordingly, since the purity of carbon dioxide recovered from a regeneration reactor as well as carbon dioxide removal rate is improved, carbon dioxide is removed in high purity without the dilution of the removed carbon dioxide. Thus, storage and compaction of carbon dioxide may be simplified and economic efficiency may be improved.

Also, a solid carbon dioxide absorbent of the present invention may reduce energy consumption required for the process by performing an absorption reaction in a flue gas temperature range (40° C. to 100° C.) and minimizing the supply of additional heat source required for regeneration (regeneration reaction temperature range: 100° C. to 200° C.), and thus, energy efficiency improvement and cost issues may be simultaneously addressed.

### BRIEF DESCRIPTION OF THE DRAWINGS

FIG. 1 is a basic conceptual view illustrating a dry CO₂ capturing device;

FIG. 2 is industrial microscope images of solid absorbents prepared in examples according to the present invention;

FIG. 3 is a resultant graph comparing equilibrium carbon dioxide sorption capacities of absorbents prepared in examples and comparative example;

FIG. 4 is a resultant graph evaluating chemical stabilities of absorbents against pollutant gas present in flue gas;

FIG. 5 is a graph illustrating the results of evaluating 10 cycle carbon dioxide sorption capacities of absorbents prepared in examples and comparative example; and

FIG. 6 is a resultant graph evaluating CO₂ sorption capacities of absorbents prepared in example and comparative example.

### MODE FOR CARRYING OUT THE INVENTION

Hereinafter, the present invention will be described in more detail.

A solid carbon dioxide absorbent composition is mixed with a solvent to prepare a slurry, and a solid carbon dioxide absorbent according to the present invention is then prepared by spray drying and sintering the slurry.

A solid carbon dioxide absorbent composition according to the present invention includes an active component, a support, and an inorganic binder, and may further include an additive.

The active component in the present invention is a material for efficiently capturing and separating carbon dioxide from a gas stream by being selectively reacted with carbon dioxide, wherein a type of the active component includes potassium carbonate, sodium carbonate, calcium oxide, calcium carbonate, mixtures thereof, or precursors thereof which may be converted into the above materials, and the active component may be a synthetic raw material or a natural raw material and may have a purity of 99% or more, but the present invention is not limited thereto.

The active component in the present invention may be included in an amount of 30 wt % to 50 wt % based on 100 wt % of the absorbent composition. In a case in which the amount of the active component is less than 30 wt %, since carbon dioxide sorption capacity is reduced, capture efficiency may be reduced. In a case in which the amount of the active component is greater than 50 wt %, the active component may not be efficiently used, a spherical shape of the absorbent may be deformed, and physical properties (strength, packing density) may be deteriorated. In the present invention, the purity of the active component may be 98% or more.

In the present invention, the support includes an aluminum compound and two or more kinds of tetravalent metal oxides. The support may simultaneously function to increase the utilization of the active component by allowing the active component to be well distributed in solid absorbent particles, to provide a passage so as to facilitate incoming and outgoing (diffusion) of gas before and after the reaction between the active substance and the outside of the particle, and to increase reaction rate by preventing inter-particle agglomeration as well as facilitating adsorption and absorption of moisture required for the reaction between the active component and carbon dioxide.

At least one selected from the group consisting of aluminum compounds of α-alumina, γ-alumina, and aluminum hydroxide (Al(OH₃)) may be used as the support.

In the present invention, the support may include 5 wt % to 30 wt % of the aluminum compound based on 100 wt % of the absorbent composition. In a case in which the amount of the aluminum compound is less than 5 wt %, the regeneration of the absorbent may not be facilitated due to a side reaction, and in a case in which the amount of the aluminum compound is greater than 30 wt %, performance may be degraded due to the dissolution of the active component.

Also, the support of the present invention may include two or more kinds of tetravalent metal oxides, for example, at least one selected from the group consisting of titanium dioxide (TiO₂) and zirconium dioxide (ZrO₂), in order to suppress the side reaction, which may occur during the repetition of regeneration cycles after absorbing carbon dioxide, by stabilizing the active component distributed in the support during the sintering process of the absorbent and to prevent the degradation of the performance of the absorbent through the contact with an air stream containing pollutants. For example, the support may include at least one selected from the group consisting of 3 wt % to 10 wt % of titanium dioxide (TiO₂) and 5 wt % to 20 wt % of zirconium dioxide.

The support of the present invention may be used in an amount of 30 wt % to 60 wt %, and the above materials are not used alone, but may be used in a combination thereof. Characteristics of each material, which functions as the support by constituting the absorbent, may also be exhibited when the materials are used in a combination thereof. In a case in which the amount of the support is less than 30 wt %, the absorption capacity of the absorbent may be reduced due to the reduction of the physical strength of the solid absorbent and the effect on the dispersion of the active component, or the performance may be degraded due to the agglomeration of the absorbent caused by moisture. In a case in which the amount of the support is greater than 60 wt %, the physical strength may be excellent, but the performance may be degraded because the amount of the active component may be relatively decreased.

The inorganic binder included in the solid absorbent raw material composition of the present invention is a material which may prepare a high-density absorbent by being densely filled in the absorbent composition, may provide strength to the absorbent by increasing a bonding force between the active component and the support, and may allow the absorbent to be used for a long period of time without loss caused by wear. At least one selected from the group consisting of cements, clays, and ceramics may be used as the inorganic binder in the present invention. In this case, a specific type of the cements may be calcium silicate, and the calcium silicate may simultaneously play a role of the support.

The calcium silicate may suppress the reduction of the performance due to the reduction of the amount of the active component in the absorbent according to the repeated use by suppressing the dissolution of the active component due to the adsorption (or absorption) of excessive moisture, and at least one selected from the group consisting of a mixture of silica (SiO₂) and calcium carbonate (CaCO₃) and a mixture of silica (SiO₂) and calcium oxide (CaO) may be used as a precursor of the calcium silicate.

A specific type of the clays may be a sodium (Na)-type bentonite, and a specific type of the ceramics may be pseudo-boehmite.

An amount of the calcium silicate, as the inorganic binder, may be in a range of 5 wt % to 20 wt % based on 100 wt % of the absorbent composition. Also, as the precursor of the calcium silicate, an amount of the calcium oxide (CaO) or the calcium carbonate (CaCO₃) may be in a range of 5 wt % to 10 wt % and an amount of the SiO₂ may be in a range of 3 wt % to 15 wt %.

Also, an amount of the inorganic binder in the present invention may be in a range of 10 wt % to 25 wt % based on 100 wt % of the absorbent composition, wherein an amount ratio of the Na-type bentonite to the pseudo-boehmite may be 50:50. In a case in which the amount of the inorganic binder is less than 10 wt %, physical properties may be deteriorated due to the reduction of the binding force between the raw materials (active component, support, and inorganic binder), and in a case in which the amount of the inorganic binder is greater than 25 wt %, since the amount of the active component and a specific surface area of the absorbent may be relatively decreased to reduce the dispersion of the active component, the absorption capacity may be decreased.

The solid carbon dioxide absorbent composition of the present invention may further include the additive. The additive may allow the solid absorbent to be used for a long period of time by suppressing the reduction of the reactivity of the absorbent due to the effect of pollutant gas according to the repeated use of the absorbent and may increase the heat transfer of the absorbent. As the additive, lanthanide oxide may be used, cerium oxide, lanthanum oxide, or a mixture thereof may be used, and a compound containing a component selected from the group consisting of CeO₂, Ce₂O₃, and La₂O₃ may be used. The additive used may be used in an amount of 1 wt % to 10 wt %. In a case in which the amount of the additive is greater than 10 wt %, mechanical strength of the prepared solid absorbent may be reduced.

In an embodiment of the present invention, a specific surface area of the aluminum compound used may be 10 m²/g or more, a specific surface area of the mixture of the silica (SiO₂) and the calcium carbonate (CaCO₃) or the calcium oxide

(CaO) may be in a range of 50 m²/g to 300 m²/g, a specific surface area of the titanium dioxide may be in a range of 30 m²/g to 400 m²/g, and a specific surface area of the zirconium dioxide (ZrO₂) may be 10 m²/g to 100 m²/g or more.

<Slurry for Preparing Solid Absorbent>

The above-described solid absorbent composition, i.e., the composition including the active component, the support, and the inorganic binder, is used as a solid raw material, and the present invention provides a slurry composition including the solid raw material and a solvent.

In the present invention, a type of the solvent is not particularly limited and any solvent may be used as long as it is generally used in the art. Specifically, water may be used as the solvent.

In the present invention, the solid raw material may be included in an amount of 20 wt % to 45 wt % based on 100 wt % of the slurry composition. In a case in which the amount of the solid raw material is less than 20 wt %, the preparation efficiency of the absorbent may eventually be reduced due to an increase in the amount of slurry for the preparation of the absorbent. In a case in which the amount of the solid raw material is greater than 45 wt %, the control of slurry stability may be difficult due to an increase in concentration of the slurry and the spray drying may be difficult to be performed because fluidity is reduced due to an increase in viscosity of the slurry.

In the present invention, a dispersant or a slurry fluidity improving agent as a type of dispersant, a defoamer, and an organic binder may be used as an organic additive which is used to provide plasticity and dispersion to the solid raw material in a process of mixing the solid raw material with water, as a solvent, among processes of preparing the solid absorbent and to homogenize the solid raw material by preventing the reduction of grinding efficiency due to an agglomeration phenomenon generated when the solid raw material is ground to fine powder (10 nm to 5,000 nm).

As the dispersant proposed in the present invention, an anionic dispersant, an amphoteric or zwitterion dispersant, or a combination thereof may be used, wherein the dispersant is suitable for the preparation of a slurry having a high concentration of 15 wt % to 60 wt %. The anionic dispersant includes polycarboxylic acid, polycarboxylic acid amine, a polycarboxylic acid amine salt, or a polycarboxylic acid sodium salt. The anionic dispersant may be used in an amount of 0.1 wt % to 5 wt % based on the total solid raw material.

The defoamer used in the present invention is used to remove bubbles of the slurry in which the dispersant and the organic binder are used, wherein metallic soap-based and polyester-based nonionic surfactants are used. The defoamer is included in an amount of 0.001 wt % to 0.5 wt % based on the total solid raw material.

Since the organic binder used in the present invention provides plasticity and fluidity to the slurry by being added in the preparation process of the slurry and eventually maintains the shape of spray-dried porous particles, the organic binder may provide strength to the particles before drying and sintering to facilitate the handling of the particles. Polyvinyl alcohols, polyethylene glycols, methylcellulose, or combinations thereof are used as the organic binder. The organic binder may be used in an amount of 0.5 wt % to 5 wt % based on the total solid raw material. In a case in which the amount of the organic binder is less than 0.5 wt %, it may be difficult to maintain the spherical shape before the drying and sintering due to the reduction of the binding force of the spray-dried solid particles, and in a case in which the amount of the organic binder is greater than 5 wt %, the performance of the final material may be degraded due to residual ash after the sintering.

In the present invention, a pH adjuster may be further added to adjust pH of the slurry composition. As the pH adjuster, for example, organic amine or ammonia water may be used, and the pH adjuster may be used by controlling the amount of the pH adjuster such that the pH is in a range of 9 to 12. When the pH is excessively low, stirring and grinding may not be possible due to an increase in the viscosity caused by the agglomeration between particles during the preparation process of the slurry, and when the pH is excessively high, damage, such as corrosion, to slurry preparation equipment or drying and sintering equipment may occur.

<Method of Preparing Solid Absorbent>

In the present invention, a method of preparing a solid absorbent using the raw material composition for preparing a solid absorbent is not particularly limited. In the present invention, for example, provided is a method of preparing a solid absorbent including the steps of: (A) preparing a slurry by mixing a solvent with the raw material composition for preparing a solid absorbent according to the present invention; (B) grinding the slurry to prepare a homogenized slurry; (C) molding solid particles by spray-drying the slurry; and (D) drying and sintering the molded solid particles.

In step (A) of the present invention, the slurry for preparing a solid absorbent may be prepared by mixing the solid raw material composition according to the present invention with the solvent. In this case, in order to suppress the agglomeration of the raw material composition and promote smooth mixing, the mixing may be performed by adding an organic additive, such as a dispersant and a defoamer, to the solvent before the addition of the solid raw material.

Step (B) according to the present invention, i.e., the preparing of the homogenized slurry, may include the steps of: adding at least one additive selected from the group consisting of a dispersant, a defoamer, a pH adjuster, and an organic binder to the slurry; and stirring and grinding the slurry.

In the adding of the additive to the mixture of the present invention, at least one selected from the group consisting of a dispersant, a defoamer, a pH adjuster, and an organic binder may be used as the additive, and, preferably, all of the above-described additives may be used. The details relating to the dispersant, the defoamer, the pH adjuster, and the organic binder are the same as described in the slurry for preparing a solid absorbent.

In the present invention, the stirring may be performed in the course of adding components included in the mixture or/and in a state in which all the components have been added. In this case, the stirring may be performed by using a stirrer.

In the present invention, a size of the particles in the slurry may be controlled to be a few microns (μm) or less by grinding the slurry, in which the mixing of the raw material composition has been completed, by using a grinder.

Since the particles ground in the process are more homogeneously dispersed in the slurry and the agglomeration of the particles in the slurry is suppressed by the dispersant already added, a homogenous and stable slurry is prepared. The grinding process may be repeated several times if necessary, the fluidity of the slurry may be adjusted by adding a dispersant and a defoamer between each grinding process, and the grinding process may be omitted when the size of the raw material composition particles is a few microns or less. An organic binder is added to maintain the shape of the particles during the spray-drying.

In order to improve the grinding effect and address limitations such as flying of the particles during dry grinding, a wet milling method may be used in the present invention. Characteristics, such as concentration and viscosity, of the slurry, in which the grinding has been completed, may be adjusted by using a dispersant, a defoamer, or an additional solvent.

In the present invention, a step of removing foreign matter in the stirred and ground slurry may be further performed.

The foreign matter or agglomerated raw material, which may be a cause of nozzle clogging during the spray-drying, may be removed through the above step. The removal of the foreign matter may be performed by sieving.

The fluidity of the final slurry prepared in the present invention is not particularly limited, and the slurry having any viscosity may be used if it may be transferred by a pump.

Step (C) of the present invention is a step of molding the slurry into solid particles by spray-drying, wherein the molding of the slurry may be performed by using a spray dryer.

In the above step, the slurry is transferred to the spray dryer by using a pump, and the transferred slurry composition may then be sprayed into the spray dryer through a pump to mold solid particles.

Appropriate operating conditions are necessary for molding a solid absorbent in the spray dryer. Operating conditions generally used in the art may be used as the operating conditions of the spray dryer for molding the solid absorbent in the spray dryer of the present invention. In an embodiment of the present invention, a solid absorbent may be molded by counter-current spraying, in which a flowable slurry is sprayed in a direction opposite to the flow of air for drying using a high-pressure nozzle, and an inlet temperature and an outlet temperature of the spray dryer may be respectively maintained in a range of 250° C. to 300° C. and 90° C. to 150° C.

Step (D) in the present invention is a step of preparing a solid absorbent by drying and sintering the solid particles prepared in step (C).

In step (D), the molded solid particles may be dried, and a solid absorbent may then be prepared by sintering the solid particles.

The drying in the present invention may be performed by drying the molded solid particles in a reflux drier at 100° C. to 150° C. for 1 hour or more. Since the drying is performed at the above temperature for the above time, a phenomenon may be prevented in which cracks occur in the particles due to the expansion of moisture in the particles during the sintering. In this case, the drying is performed in an air atmosphere.

Once the drying is complete, the dried particles are put in a high-temperature sintering furnace, a final sintering temperature is increased to 450° C. to 150° C. at a rate of 1° C./min to 5° C./min, and the sintering is then performed by holding the final sintering temperature for 2 hours or more. In a case in which the sintering time is less than 2 hours, strength of the particles may be reduced. In the present invention, the sintering may be performed after providing each holding period of 30 minutes or more at holding temperatures of two or more steps up to the final sintering temperature.

In the present invention, a sintering furnace, such as a muffle furnace, a tubular furnace, or a kiln, may be used in the sintering.

In the present invention, the organic additives (dispersant, defoamer, and organic binder) added during the preparation of the slurry are burned and bonds between the raw materials are formed to improve the strength of the particles.

In the present invention, a carbon dioxide sorption capacity of the solid absorbent may be 5 wt % (5 g CO₂/100 g sorbent) or more. With respect to the regeneration performance of the absorbent of the present invention, a regeneration of 70% or more may be possible at a temperature of 250° C. or less while supplying a gas containing carbon dioxide, water vapor, air, and a mixed gas thereof, and carbon dioxide of a regeneration reactor may have a purity of 80% or more. Also, since the absorption capacity of the solid absorbent is not reduced by pollutant gas in the gas containing carbon dioxide, the absorbent may be reused.

<Method of Removing Carbon Dioxide in Gas>

Provided is a method of removing carbon dioxide in a gas including: absorbing carbon dioxide by reacting a gas containing carbon dioxide with the solid absorbent prepared using the raw material composition for preparing a solid absorbent according to the present invention; and regenerating the solid absorbent at a temperature of 250° C. or less by contacting the carbon dioxide-absorbed solid absorbent with carbon dioxide, water vapor, air, and a mixed gas thereof.

When the solid absorbent is reacted with the gas containing carbon dioxide as well as water vapor, potassium carbonate (K₂CO₃) or sodium carbonate (Na₂CO₃) , as the active component of the solid absorbent, becomes potassium bicarbonate (KHCO₃) or sodium bicarbonate (NaHCO₃) by absorbing carbon dioxide, and when the carbon dioxide-absorbed solid absorbent is in contact with carbon dioxide, water vapor, air, and a mixed gas thereof at a temperature of 250° C. or less, the potassium bicarbonate (KHCO₃) or sodium bicarbonate (NaHCO₃), as the active component of the solid absorbent, is regenerated into potassium carbonate (K₂CO₃) or sodium carbonate (Na₂CO₃) while water vapor and carbon dioxide are discharged.

In the method of removing carbon dioxide of the present invention, the process as described above is repeated.

The gas containing carbon dioxide, which is considered in the present invention, is not particularly limited, and, for example, may be a combustion gas which is generated by combustion of a fossil fuel such as coal, natural gas, and biomass.

Also, the provision of the carbon dioxide, water vapor, and mixed gas thereof, which are used in the regeneration of the carbon dioxide-absorbed solid absorbent, may be performed by the circulation of the gas recovered from the regeneration reactor.

<Carbon Dioxide Capturing Device>

The present invention also provides a dry carbon dioxide capturing device including: an absorption reactor in which the gas containing carbon dioxide is in contact with the solid absorbent according to the present invention to generate a reaction in which the solid absorbent absorbs carbon dioxide; and a regeneration reactor in which the carbon dioxide-absorbed solid absorbent is in contact with carbon dioxide, water vapor, air, nitrogen, or a mixed gas thereof at a temperature of 250° C. or less to regenerate the solid absorbent.

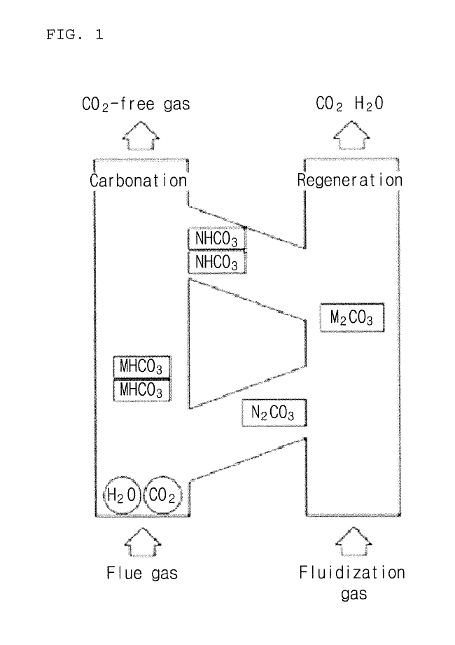

The absorption reactor and the regeneration reactor in the present invention may be configured to be connected to each other as illustrated in a basic conceptual view of a dry CO₂ capturing device in FIG. 1.

The solid carbon dioxide absorbent may be in contact with carbon dioxide to have a removal rate of a carbon dioxide concentration of an absorption reactor outlet to a carbon dioxide concentration of an absorption reactor inlet of 50% or more.

Also, the solid carbon dioxide absorbent may maintain a carbon dioxide purity of the regeneration reactor of 50% or more through the regeneration of the solid carbon dioxide absorbent by circulating a gas discharged from the regeneration reactor at a temperature of 250° C. or less.

Hereinafter, the present invention will be described in more detail according to specific examples and comparative examples in such a manner that it may easily be carried out by a person with ordinary skill in the art to which the present invention pertains. However, the scope of the present invention is not limited the disclosed examples.

### EXAMPLE 1

In the present example, a solid absorbent was prepared by preparing a composition including 40 wt % of potassium carbonate (K₂CO₃) as an active component; 14 wt % of alpha alumina (α-Al₂O₃), an alumina compound, (purity of 99% or more, powder form, average particle diameter of 5 μpm or less), 5 wt % of titania (purity of 90% or more, average particle diameter of 1 pm or less), and 12 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; a mixture (purity of 90% or more, powder form, average particle diameter of 45 μm or less) of 6 wt % of CaO and 9 wt % of SiO₂ as a calcium silicate precursor; and 4 wt % of cerium oxide (Ce₂O₃), among lanthanide oxides, as an additive in total 8 kg of solid raw material.

Distilled water was weighed so that a total weight of the solid raw material included in a slurry was 35 wt %, and the active component was first dissolved. Then, in order to prevent non-uniform mixing due to the agglomeration between particles in a mixing process of the raw material, the Na-type bentonite as a basic material (pH of 9 or more), the pseudo-boehmite, and calcium silicate were first added and mixed. Thereafter, a mixed slurry was prepared by adding small amounts of the support and the additive in sequence, and the slurry was stirred at a speed of 10,000 rpm to 25,000 rpm for 10 minutes or more using a dual helix mixer in order to prevent the sedimentation of particles having a relatively high specific gravity or large size in the solid raw material of the mixed slurry.

In this case, a small amount of a dispersant was added to facilitate the mixing and dispersion of the solid material before and after the addition of the raw materials depending on the viscosity of the mixed slurry and the degree of the stirring. A small amount of a defoamer was added after the addition of the dispersant or depending on the amount of bubbles generated in the stirring process of the slurry.

After the stirring, the solid raw material particles in the slurry were ground twice or more and homogenized using a high-energy bead mill to prepare a final slurry. In this case, additional water, dispersant, defoamer, and pH adjuster (organic amine) were added to control characteristics of the slurry, such as viscosity of the slurry, concentration of the solid raw material, and pH, or for ease of operation. A glycol-based organic binder was added so as to be uniformly dispersed in the slurry before the final grinding.

In order to remove foreign matter which may be introduced in the preparation process, the above-described final slurry obtained through the control of the characteristics of the slurry was sieved, a concentration of the solid content was then controlled to be in a range of 25 wt % to 35 wt %, and the final slurry was spray-dried to prepare solid particles.

The prepared solid particles were dried in an air atmosphere at a temperature of 100° C. or more for 2 hours or more in a dryer, the temperature of a muffle furnace was then increased to a final sintering temperature of 500° C. to 750° C. at a rate of 0.5° C./min to 10° C./min, and the solid particles were then maintained at the final temperature for 2 hours or more to prepare a final absorbent. In order to effectively remove the organic additives and organic binder added in the preparation process of the slurry, the solid particles were maintained for 30 minutes or more at each temperature of 200° C., 400° C., and 500° C. before reaching the final sintering temperature.

### EXAMPLE 2

In the present example, a solid absorbent was prepared in the same manner as in Example 1 by preparing a composition including 40 wt % of potassium carbonate (K₂CO₃) as an active component; 15 wt % of alpha alumina (purity of 99% or more, powder form, d50=1 μm or less), 5 wt % of titania (purity of 90% or more, average particle diameter of 1 μm or less), and 12 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; a mixture of 5 wt % of CaO and 8 wt % of SiO₂ as a calcium silicate precursor; and 2.5 wt % of lanthanum oxide (La₂O₃) and 2.5 wt % of cerium oxide (Ce₂O₃), among lanthanide oxides, as an additive in total 8 kg of solid raw material.

### EXAMPLE 3

In the present example, a solid absorbent was prepared in the same manner as in Example 1 by preparing a composition including 40 wt % of potassium carbonate (K₂CO₃) as an active component; 14 wt % of alpha alumina (purity of 99% or more, powder form, d50=1 μm or less), 3 wt % of gamma alumina (purity of 95% or more, powder form, d50 =6 μm or less, specific surface area of 150 m²/g), 5 wt % of titania (purity of 90% or more, average particle diameter of 1 μm or less) , and 13 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; and a mixture (purity of 90% or more, powder form, average particle diameter of 45 μm or less) of 6 wt % of CaO and 9 wt % of SiO₂ as a calcium silicate precursor in total 8 kg of solid raw material.

### EXAMPLE 4

In the present example, a solid absorbent was prepared in the same manner as in Example 1 except that a composition was prepared by including 40 wt % of potassium carbonate (K₂CO₃) as an active component; 25 wt % of aluminum hydroxide (Al(OH)₃, purity of 99% or more, powder form, average particle diameter of 0.5 μm or less), 3 wt % of fumed silica, 5 wt % of titania (purity of 90% or more, average particle diameter of 1 μm or less), and 10 wt % of zirconia (ZrO₂) as a support; 7 wt % of calcium silicate (purity of 90% or more, powder form, average particle diameter of 45 μm or less), 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder in total 8 kg of solid raw material, and the Na-type bentonite as a basic material (pH of 9 or more), pseudo-boehmite, and calcium silicate were first added and mixed in order to prevent non-uniform mixing due to the agglomeration between particles in a mixing process of the raw materials.

### EXAMPLE 5

In the present example, a solid absorbent was prepared in the same manner as in Example 1 by preparing a composition including 40 wt % of potassium carbonate (K₂CO₃) as an active component; 14 wt % of alpha alumina (purity of 99% or more, powder form, d50 =1 μm or less), 4 wt % of aluminum hydroxide (Al(OH)₃, purity of 99% or more, powder form, average particle diameter of 0.5 μm or less), 5 wt % of titania (purity of 90% or more, average particle diameter of 1 μm or less), and 12 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; and a mixture (purity of 90% or more, powder form, average particle diameter of 45 μm or less) of 6 wt % of CaO and 9 wt % of SiO₂ as a calcium silicate precursor in total 8 kg of solid raw material.

### EXAMPLE 6

In the present example, a solid absorbent was prepared in the same manner as in Example 1 by preparing a composition including 40 wt % of potassium carbonate (K₂CO₃) as an active component; 14 wt % of alpha alumina (purity of 99% or more, powder form, d50=1 μm or less), 5 wt % of titania (purity of 90% or more, average particle diameter of 1 μm or less), and 12 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; and a mixture (purity of 90% or more, powder form, average particle diameter of 45 μm or less) of 5 wt % of CaO and 14 wt % of SiO₂ as a calcium silicate precursor in total 8 kg of solid raw material.

### EXAMPLE 7

In the present example, a solid absorbent was prepared in the same manner as in Example 1 by preparing a composition including 40 wt % of potassium carbonate (K₂CO₃) as an active component; 15 wt % of alpha alumina (purity of 99% or more, powder form, d50=1 μm or less), 6 wt % of titania (purity of 90% or more, average particle diameter of 1 μm or less), and 13 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; and a mixture (purity of 90% or more, powder form, average particle diameter of 45 μm or less) of 6 wt % of CaO and 10 wt % of SiO₂ as a calcium silicate precursor in total 8 kg of solid raw material.

### EXAMPLE 8

In the present example, a solid absorbent was prepared in the same manner as in Example 1 by preparing a composition including 35 wt % of potassium carbonate (K₂CO₃) as an active component; 21 wt % of aluminum hydroxide (Al(OH)₃, purity of 99% or more, powder form, average particle diameter of 0.5 μm or less), 4 wt % of gamma alumina (purity of 95% or more, powder form, d50=6 μm or less, specific surface area of 150 m²/g), 5 wt % of titania (purity of 90% or more, average particle diameter of 1 μm or less), and 12 wt % of zirconia (ZrO₂) as a support; 5 wt % of pseudo-boehmite (alumina content of 75% or more, powder form, average particle diameter of 50 μm or less) and 5 wt % of Na-type bentonite (powder form, average particle diameter of 50 μm or less) as an inorganic binder; and a mixture (purity of 90% or more, powder form, average particle diameter of 45 μm or less) of 5 wt % of CaO and 8 wt % of SiO₂ as a calcium silicate precursor in total 8 kg of solid raw material.

### Comparative Examples 1 to 4 and Example 9

Slurries and solid absorbents were prepared in the same manner as the above example, according to raw material compositions listed in Table 2.

Table 1 summarizes the compositions of the raw materials used in the solid absorbents, which were prepared according to the present examples, and characteristics of the colloidal slurries.

Table 2 summarizes the compositions of the raw materials used in the solid absorbents, which were prepared according to the present example and comparative examples, and characteristics of the colloidal slurries.

TABLE 1

| Category | Example 1 | Example 2 | Example 3 | Example 4 | Example 5 | Example 6 | Example 7 | Example 8 |
|---|---|---|---|---|---|---|---|---|
| K₂CO₃ (wt %) | 40 | 40 | 40 | 40 | 40 | 40 | 40 | 35 |
| α-alumina | 14 | 15 | 14 | — | 14 | 14 | 15 | — |
| (wt %) | | | | | | | | |
| Al(OH)₃ (wt %) | — | — | — | 25 | 4 | — | — | 21 |
| γ-alumina | — | — | 3 | — | — | — | — | 4 |
| (wt %) | | | | | | | | |
| Silica (wt %) | 9 | 8 | 9 | 3 | 9 | 14 | 10 | 8 |
| CaO (wt %) | 6 | 5 | 6 | — | 6 | 5 | 6 | 5 |
| Calcium | — | — | — | 7 | — | — | — | — |
| silicate | | | | | | | | |
| (wt %) | | | | | | | | |
| Pseudo- | 5 | 5 | 5 | 5 | 5 | 5 | 5 | 5 |
| boehmite | | | | | | | | |
| (wt %) | | | | | | | | |
| Na-bentonite | 5 | 5 | 5 | 5 | 5 | 5 | 5 | 5 |
| (wt %) | | | | | | | | |
| TiO₂ | 5 | 5 | 5 | 5 | 5 | 5 | 6 | 5 |
| (anatase) | | | | | | | | |
| (wt %) | | | | | | | | |
| ZrO₂ (wt %) | 12 | 12 | 13 | 10 | 12 | 12 | 13 | 12 |
| Ce₂O₃ (wt %) | 4 | 2.5 | — | — | — | — | — | — |
| La₂O₃ (wt %) | — | 2.5 | — | — | — | — | — | — |
| Total solid | 100 | 100 | 100 | 100 | 100 | 100 | 100 | 100 |
| raw material | | | | | | | | |
| (wt %) | | | | | | | | |
| Dispersant | 0.33 | 0.33 | 0.33 | 2.73 | 2.73 | 2.73 | 2.73 | 0.5 |
| (wt %) | | | | | | | | |
| Defoamer | 0.033 | 0.033 | 0.033 | 0.033 | 0.033 | 0.033 | 0.033 | 0.025 |
| (wt %) | | | | | | | | |
| Organic | 2.23 | 2.23 | 2.23 | 2.23 | 2.23 | 2.23 | 2.23 | 2.24 |
| binder (wt %) | | | | | | | | |
| Slurry | 33.0 | 34.8 | 28.1 | 30.7 | 34.8 | 30.7 | 30.7 | 32.0 |
| concentration | | | | | | | | |
| (wt %) | | | | | | | | |
| Slurry pH | 11.40 | 11.32 | 11.18 | 11.65 | 11.47 | 11.65 | 11.65 | 11.81 |
| Viscosity | 1,350 | 1,100 | 1,570 | 600 | 2,220 | 600 | 600 | 3,500 |
| (cP) | | | | | | | | |

TABLE 2

| | | Comparative | Comparative | Comparative | Comparative | |
|---|---|---|---|---|---|---|
| Category | | Example 1 | Example 2 | Example 3 | Example 4 | Example 9 |
| K₂CO₃ (wt %) | | 40 | 40 | 40 | 35 | 35 |
| γ-alumina | 150 m²/g | 23 | 23 | — | 38 | 4 |
| (wt %) | 250 m²/g | — | — | 33 | — | — |

| | | | | | |
|---|---|---|---|---|---|
| α-alumina (wt %) | — | — | — | — | 21 |
| Calcium silicate | 7 | 7 | 7 | 7 | 13 |
| (wt %) | | | | | |
| Pseudo-boehmite | 5 | 5 | 5 | 5 | 5 |
| (wt %) | | | | | |
| Na-bentonite (wt. %) | 5 | 5 | 5 | 5 | 5 |
| TiO₂ (anatase) | 20 | — | 10 | — | 5 |
| (wt %) | | | | | |
| ZrO₂ (wt %) | — | 20 | — | 10 | 12 |
| Total solid raw | 100 | 100 | 100 | 100 | 100 |
| material (wt %) | | | | | |
| Non-ionic | — | — | 2.5 | 0.5 | 0.3 |
| dispersant (wt %) | | | | | |
| Anionic dispersant | 0.5 | 0.5 | 0.02 | 0.33 | 0.02 |
| (wt %) | | | | | |
| Defoamer (wt %) | 0.03 | 0.03 | 0.07 | 0.10 | 1.34 |
| Organic binder | 2.23 | 2.23 | 2.80 | 2.23 | 2.23 |
| (wt %) | | | | | |
| Slurry | 30.7 | 30.6 | 31.3 | 34.0 | 31.5 |
| concentration | | | | | |
| (wt %) | | | | | |
| Slurry pH | 10.86 | 13.93 | 11.38 | 10.8 | 11.70 |
| Viscosity (cP) | 1,180 | 2,860 | 36,000 | 1,710 | 1,050 |

### Experimental Examples

(1) Shape Measurement of Solid Absorbent

Shapes of the solid absorbents were measured visually and by using an industrial microscope or scanning electron microscope (SEM).

(2) CO₂ Sorption Capacity Measurement

Equilibrium carbon dioxide sorption capacities of the solid absorbents were evaluated by using a thermal gravimetric analyzer (TGA) or a fixed bed reactor.

For the measurement of the carbon dioxide sorption capacity using the thermal gravimetric analyzer, an absorption reaction was performed at 70° C. and regeneration was performed at 140° C. while supplying 14.4 vol of CO₂, 5.4 vol % of O₂, 73.2 vol % of N₂, and 7 vol % of H₂O at a rate of 60 Ml/min.

For the measurement of the absorption capacity using the fixed bed reactor, 0.5 g of the absorbent was put in the fixed bed reactor having a diameter of 1 cm, reaction gas including 1 vol % of CO₂ and 9 vol % of H₂O was supplied at a rate of 40 Ml/min, and the measurement was performed until a CO₂ concentration at a reactor inlet was the same as a CO₂ concentration at a reactor outlet. An absorption reaction of the absorbent was performed at 60° C. and regeneration was performed at 150° C. in a nitrogen atmosphere.

For the evaluation of effects of pollutant gas on the solid absorbent and dynamic absorption capacity, 10 g of the absorbent was put in a batch type bubbling fluidized bed reactor having a diameter of 2.5 cm, a simulation flue gas containing 13.9 vol % of CO₂, 5.3 vol % of O₂, 14.3 vol % of H₂O, and 66.5 vol % of N₂ was supplied through the reactor at a rate of 250 Ml/min for 60 minutes, an absorption reaction was performed at 70° C., and regeneration was performed at 140° C. in a nitrogen atmosphere.

The measurement results of CO₂ sorption capacities of the solid absorbents of the examples and comparative examples are presented in Table 3.

TABLE 3

| Category | CO₂ sorption capacity, wt % |
|---|---|
| Example 1 | 11.11 |
| Example 2 | 11.01 |
| Example 3 | 11.23 |
| Example 4 | 10.02 |
| Example 5 | 10.83 |
| Example 6 | 11.01 |
| Example 7 | 11.3 |
| Example 8 | 9.45 |
| Comparative | 6.27 |
| Example 1 | |
| Comparative | 7.86 |
| Example 2 | |
| Comparative | 6.24 |
| Example 3 | |
| Comparative | 9.03 |
| Example 4 | |
| Example 9 | 9.7 |

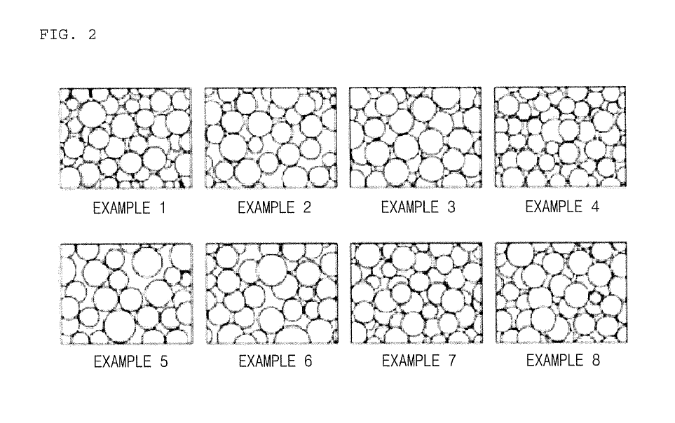

FIG. 2 illustrates industrial microscope images of the solid absorbents according to Examples 1 to 8 of the present invention. As illustrated in FIG. 2, the solid absorbents prepared in the present examples had a spherical shape.

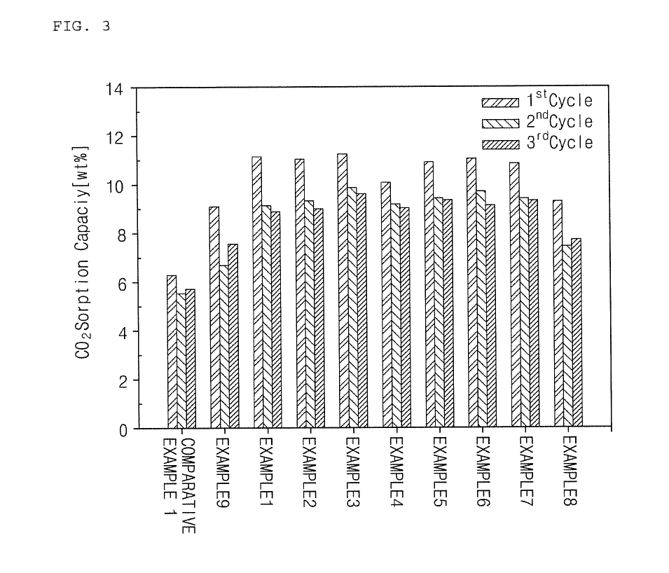

FIG. 3 illustrates results comparing equilibrium carbon dioxide sorption capacities of the absorbents prepared in examples and comparative example using the above-described fixed bed reactor, wherein the absorbents prepared in the examples of the present invention maintained excellent carbon dioxide sorption capacities in both initial reaction and continuous reaction in comparison to the absorbent prepared in the comparative example.

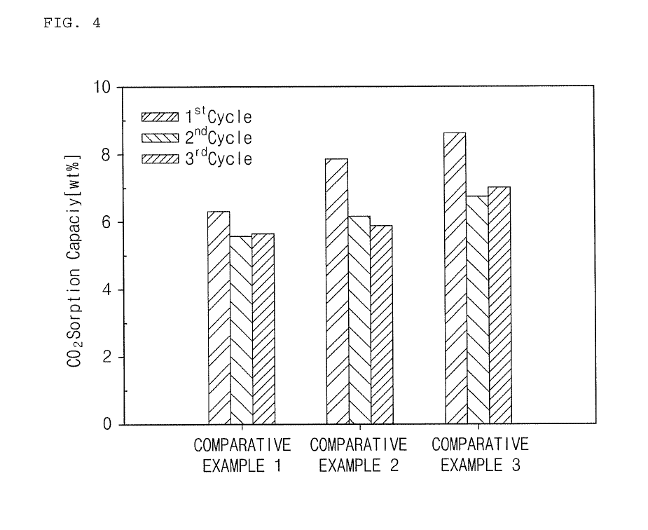

In FIG. 4, chemical stabilities of the absorbents against pollutant gas present in flue gas were evaluated by supplying a simulation flue gas containing 13.9 vol % of CO₂, 5.3 vol % of O₂, 14.3 vol % of H₂O, and 66.5 vol % of N₂ at a rate of 250 Ml/min with 100 ppm SO₂ to the solid absorbents prepared in Example 1 using a batch type bubbling fluidized bed reactor. With respect to Comparative Example 1, a simulation flue gas not containing SO₂ was supplied, and, with respect to Comparative Example 2, the sorption capacity was evaluated by supplying a simulation flue gas containing 35 ppm SO₂. As illustrated in FIG. 4, it was confirmed that the absorbent suggested in the present invention had excellent CO₂ sorption capacity and regeneration of the absorbent in an SO₂ atmosphere.

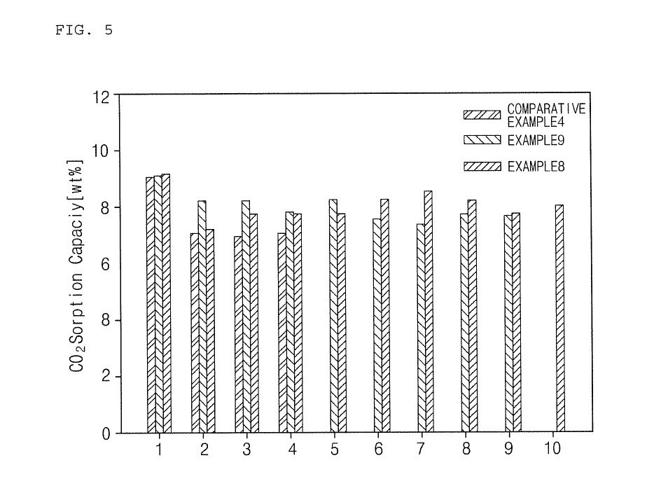

FIG. 5 illustrates the results of evaluating 10 cycle CO₂ sorption capacities of the absorbents, in which 10 g of each absorbent was put in a batch type bubbling fluidized bed reactor having a diameter of 2.5 cm, a simulation flue gas containing 13.9 vol % of CO₂, 5.3 vol % of O₂, 14.3 vol % of H₂O, and 66.5 vol % of N₂ was supplied through the reactor at a rate of 250 Ml/min, an absorption reaction was performed at 70° C., and regeneration was performed at 140° C. in a nitrogen atmosphere. It was confirmed that CO₂ sorption capacities of Examples 8 and 9 were better than CO₂ sorption capacity of Comparative Example 4.

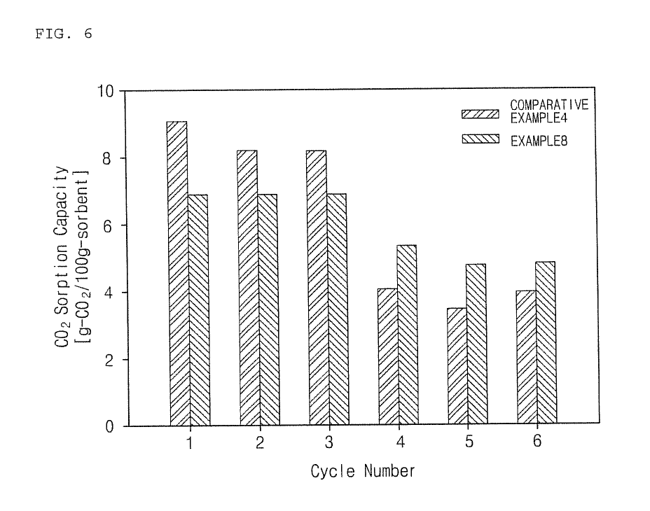

FIG. 6 illustrates the results of evaluating CO₂ sorption capacities of the absorbents prepared in Comparative Example 4 and Example 8 using the batch type bubbling fluidized bed reactor at the same absorption reaction temperature and regeneration reaction temperature, in which the CO₂ sorption capacities were evaluated until a 6^{th} regeneration reaction while performing regeneration after a second absorption reaction in a nitrogen atmosphere and supplying 100% CO₂ beginning with a third regeneration reaction. As illustrated in FIG. 6, the absorbent of Example 8 exhibited lower CO₂ sorption capacity than the absorbent of Comparative Example 4 during N₂ regeneration, but, as the result of the regeneration of the absorbent using 100% CO₂, the absorbent of Example 8 exhibited a better result than the absorbent prepared in the comparative example and was stabilized by maintaining about 70% of its initial sorption capacity. This indicated that since the absorbent prepared according to the present invention may be regenerated while recirculating a gas discharged through the regeneration reactor to have a CO₂ purity of 90% or more, the absorbent may recover the gas into high-purity CO₂.

As the result of evaluating a CO₂ removal rate of the absorbent of Example 7 through a dry CO₂ capture process at a scale of 2,000 Nm³/h linked to actual flue gas of a thermal power plant based on the above result, the removal rate from the actual flue gas having a CO₂ concentration of 13.5% was maintained in a range of 80% to 90%, and a CO₂ purity of the regeneration reactor was maintained at 85% or more. In this case, moisture was supplied such that a ratio of the supplied moisture to CO₂ was in a range of 1.1 to 1.8, and a temperature of the regeneration reactor was maintained in a range of 180° C. to 200° C. while circulating a gas of the regeneration reactor which was regenerated to have a CO₂ purity of 90% or more.

As described above, the constitution and operation of the present invention has been described based on preferred embodiments according to the present invention. However, the present invention is not limited to the above embodiments, and it is possible for one who has an ordinary skill in the art to make various modifications and variations without departing from the spirit and scope of the present invention, as defined by the appended claims.

### INDUSTRIAL APPLICABILITY

The solid carbon dioxide absorbent composition according to the present invention may significantly improve carbon dioxide sorption capacity as well as regeneration capacity of the absorbent in a high concentration carbon dioxide atmosphere. Accordingly, since the purity of carbon dioxide recovered from a regeneration reactor as well as carbon dioxide removal rate is improved, carbon dioxide is removed in high purity without the dilution of the removed carbon dioxide. Thus, storage and compaction of carbon dioxide may be simplified and economic efficiency may be improved.

1. A solid carbon dioxide absorbent composition for removing carbon dioxide, the composition comprising:
an active component;
a support; and
an inorganic binder,
wherein the support comprises an aluminum compound and two or more kinds of tetravalent metal oxides.

2. The solid carbon dioxide absorbent composition of claim 1, wherein the active component comprises at least one selected from the group consisting of potassium carbonate, sodium carbonate, calcium oxide, calcium carbonate, and precursors thereof, and is included in an amount of 30 wt % to 50 wt % based on 100 wt % of the absorbent composition.

3. The solid carbon dioxide absorbent composition of claim 1, wherein the aluminum compound comprises at least one selected from the group consisting of α-alumina, γ-alumina, and aluminum hydroxide, and is included in an amount of 5 wt % to 30 wt % based on 100 wt % of the absorbent composition.

4. The solid carbon dioxide absorbent composition of claim 1, wherein the tetravalent metal oxide comprises titanium dioxide and zirconium dioxide.

5. The solid carbon dioxide absorbent composition of claim 4, wherein the titanium dioxide is included in an amount of 3 wt % to 10 wt % and the zirconium dioxide is included in an amount of 5 wt % to 20 wt % based on 100 wt % of the absorbent composition.

6. The solid carbon dioxide absorbent composition of claim 1, wherein the inorganic binder comprises at least one selected from the group consisting of calcium silicate, Na-type bentonite, and pseudo-boehmite.

7. The solid carbon dioxide absorbent composition of claim 6, wherein the calcium silicate is included in an amount of 5 wt % to 20 wt % based on 100 wt % of the absorbent composition.

8. The solid carbon dioxide absorbent composition of claim 6, wherein 5 wt % to 10 wt % of calcium oxide (CaO) or calcium carbonate (CaCO₃) and 3 wt % to 15 wt % of SiO₂ are included as a calcium silicate precursor.

9. The solid carbon dioxide absorbent composition of claim 8, wherein a weight ratio of the calcium oxide (CaO) or calcium carbonate (CaCO₃) to the silica (SiO₂) in the calcium silicate precursor is in a range of 1:1.5 to 1:3.5.

10. The solid carbon dioxide absorbent composition of claim 6, wherein the Na-type bentonite and the pseudo-boehmite are included in a weight ratio of 1:1 and in an amount of 10 wt % to 25 wt %.

11. The solid carbon dioxide absorbent composition of claim 1, further comprising a lanthanide oxide as an additive.

12. The solid carbon dioxide absorbent composition of claim 11, wherein the lanthanide oxide comprises a cesium oxide, a lanthanum oxide, or a mixture thereof, and is included in an amount of 1 wt % to 10 wt %.

13. A solid carbon dioxide absorbent comprising the solid carbon dioxide absorbent composition of claim 1.

14. A dry carbon dioxide capturing device comprising:
an absorption reactor in which the solid carbon dioxide absorbent of claim 13 is in contact with gas containing carbon dioxide to generate a reaction in which the solid carbon dioxide absorbent absorbs the carbon dioxide; and
a regeneration reactor in which the carbon dioxide-absorbed solid carbon dioxide absorbent is in contact with carbon dioxide, air, nitrogen, water vapor, or a mixed gas thereof at a temperature of 250° C. or less to generate a reaction in which the solid carbon dioxide absorbent is regenerated.

15. The dry carbon dioxide capturing device of claim 14, wherein the solid carbon dioxide absorbent is in contact with the carbon dioxide to have a removal rate of a carbon dioxide concentration of an absorption reactor outlet to a carbon dioxide concentration of an absorption reactor inlet of 50% or more.

16. The dry carbon dioxide capturing device of claim 14, wherein the solid carbon dioxide absorbent maintains a carbon dioxide purity of the regeneration reactor of 50% or more through regeneration of the solid carbon dioxide absorbent by circulating a gas discharged from the regeneration reactor at a temperature of 250° C. or less.
